(19) United States
(12) Patent Application Publication
(10) Pub. No.: US 2025/0106739 A1
(43) Pub. Date: Mar. 27, 2025

(54) METHOD AND APPARATUS FOR SUPPORTING MOBILITY OF USER EQUIPMENT

(71) Applicant: SAMSUNG ELECTRONICS CO., LTD., Suwon-si (KR)

(72) Inventor: Kyungjoo SUH, Suwon-si (KR)

(21) Appl. No.: 18/898,339

(22) Filed: Sep. 26, 2024

(30) Foreign Application Priority Data
Sep. 26, 2023 (KR) 10-2023-0129576

(51) Int. Cl. H04W 48/14; H04W 60/04; H04W 76/12; H04W 84/06

(52) U.S. Cl. CPC H04W 48/14; H04W 60/04; H04W 76/12; H04W 84/06

(57) ABSTRACT

Provided is a 5th generation (5G) or 6th generation (6G) communication system for supporting a higher data rate. A method performed by a user equipment may include transmitting a registration request message to an access and mobility management function (AMF), receiving a registration accept message from the AMF, transmitting a protocol data unit (PDU) session establishment request message to a session management function (SMF), receiving a PDU session establishment accept message from the SMF, and receiving a configuration update message from the AMF.

### CROSS-REFERENCE TO RELATED APPLICATION

This application is based on and claims priority under 35 U.S.C. § 119 to Korean Patent Application Nos. 10-2023-0129576, filed on Sep. 26, 2023, in the Korean Intellectual Property Office, the disclosure of which is incorporated by reference herein in its entirety.

### BACKGROUND

### 1. Field

The disclosure relates to an apparatus and method for supporting mobility of a user equipment. More particularly, the disclosure relates to an apparatus and method for supporting mobility of a user equipment when communication is performed by using a cellular network and a satellite radio access network (RAN), in a wireless communication system.

### 2. Description of the Related Art

5th generation (5G) mobile communication technology defines a wide frequency band to enable a fast transmission speed and a new service, and is implemented not only in a sub 6 gigahertz (GHz) frequency band, such as 3.5 GHz, but also in an above 6 GHz ultra-high frequency band referred to as millimeter wave (mmWave), such as 28 GHz and 39 GHz. Also, in 6th generation (6G) mobile communication technology also referred to as a beyond 5G system, implementation in a terahertz (THz) band (e.g., a 3 THz in 95 GHz) is considered to achieve a transmission speed 50 times faster than 5G mobile communication technology and an ultra low latency time reduced to 1/10 of 5G mobile communication technology.

In early stages of 5G mobile communication technology, standardization has been performed on beamforming and massive multiple-input multiple-output (MIMO) for alleviating a pass loss of radio waves and increasing a transmission distance of radio waves in an ultra-high frequency band, support of various numerologies (an operation of a plurality of subcarrier intervals) and a dynamic operation of slot formats for efficient use of ultra-high frequency resources, initial access technology for supporting multi-bean transmission and wideband, definition and operation of a bandwidth part (BWP), a new channel coding method, such as polar code, for highly reliable transmission of control information and low density parity check (LDPC) code for massive data transmission, L2 pre-processing, and network slicing providing a dedicated network specialized for a specific service, targeting at service support and performance requirement satisfaction for enhanced mobile broadband (eMBB), ultra-reliable low-latency communications (URLLC), and massive machine-type communications (mMTC).

Currently, discussions are being held to improve and enhance initial 5G mobile communication technology in consideration of services that were to be supported by 5G mobile communication technology, and physical layer standardization is being performed on vehicle-to-everything (V2X) for assisting driving determination of an autonomous vehicle and increasing user convenience, based on its location and status information transmitted by the vehicle, new radio unlicensed (NR-U) targeting at a system operation matching various regulatory requirements in an unlicensed band, NR user equipment (UE) low power consumption technology (UE power saving), non-terrestrial network (NTN) that is direct UE-satellite communication for coverage securement in areas where communication with terrestrial networks is impossible, and positioning.

In addition, standardization of wireless interface architectures/protocols is being performed for industrial Internet of things (IIoT) for supporting new services through linkage and convergence with other industries, integrated access and backhaul (IAB) providing nodes for expanding network service areas by integrally supporting wireless backhaul links and access links, mobility enhancement including conditional handover and dual active protocol stack (DAPS) handover, and 2-step random access channel (RACH) for NR for simplifying random access procedures, and standardization of system architectures/services is also being performed for 5G baseline architectures (e.g., service-based architectures and service-based interfaces) for grafting network functions virtualization (NFV) onto software-defined networking (SDN) technology, and mobile edge computing (MEC) for receiving services based on locations of UEs.

When such a 5G mobile communication system is commercialized, connected devices that have been explosively increased may be connected to a communication network and accordingly, it is anticipated that functions and performance of the 5G mobile communication system need to be reinforced and the connected devices need to be integrally operated. In this regard, new studies will be conducted on extended reality (XR) for efficiently supporting augmented reality (AR), virtual reality (VR), and mixed reality (MR), 5G performance improvement and complexity reduction using artificial intelligence (AI) and machine learning (ML), AI service support, metaverse service support, and drone communication.

Such development of a 5G mobile communication system may serve as the basis for development of not only multi-antenna transmission technology, such as new waveform, full dimensional (FD)-MIMO, array antenna, and large scale antenna, for coverage securement in THz band of 6G mobile communication technology, higher-dimensional space multiplexing technology using metamaterial-based lens and antenna and orbital angular momentum (OAM) for improving coverage of a THz band signal, and reconfigurable intelligent surface (RIS) technology, but also full duplex technology for improving frequency efficiency and enhancing a system network of 6G mobile communication technology, AI-based communication technology that uses a satellite and AI from a design stage and realizes system optimization by internalizing end-to-end AI support function, and next-generation distributed computing technology that realizes a service with complexity exceeding limits of UE computing capability by using ultra-high performance communication and computing resources.

### SUMMARY

Additional aspects will be set forth in part in the description which follows and, in part, will be apparent from the description, or may be learned by practice of the presented embodiments of the disclosure.

A method performed by a user equipment, according to an embodiment of the disclosure, may include transmitting a registration request message to an access and mobility management function (AMF).

The method performed by the user equipment, according to an embodiment of the disclosure, may include receiving a registration accept/reject message from the AMF.

The method performed by the user equipment, according to an embodiment of the disclosure, may include transmitting a protocol data unit (PDU) session establishment request message to a session management function (SMF).

The method performed by the user equipment, according to an embodiment of the disclosure, may include receiving a PDU session establishment accept message from the SMF.

The method performed by the user equipment, according to an embodiment of the disclosure, may include receiving a configuration update message from the AMF.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a user equipment (UE) and network environment for wireless communication in an environment where 5th generation (5G) communication and satellite communication are supported, according to an embodiment of the disclosure;

FIG. 2 illustrates a flowchart of a procedure for performing communication in an environment where 5G communication and satellite communication are supported, according to an embodiment of the disclosure;

FIG. 3 illustrates a flowchart of a procedure for performing communication in an environment where 5G communication and satellite communication are supported, according to an embodiment of the disclosure;

FIG. 4 illustrates a flowchart of a procedure for performing communication in an environment where 5G communication and satellite communication are supported, according to an embodiment of the disclosure;

FIG. 5 illustrates a diagram of a configuration of a UE, according to an embodiment of the disclosure; and

FIG. 6 illustrates a diagram of a configuration of a network entity, according to an embodiment of the disclosure.

### DETAILED DESCRIPTION

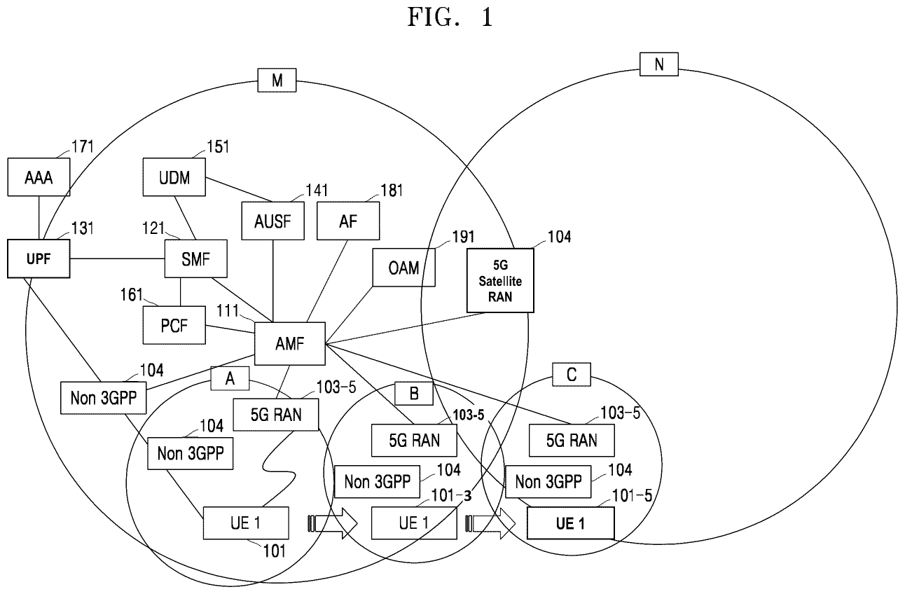

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

When a user equipment (UE) uses satellite communication and a cellular network in a mobility situation, coverage of a satellite covers variously depending on types of satellites, unlike a small cell of general 5th generation (5G) new radio (NR). Accordingly, a method is required to manage UE registration, UE state transition, and UE mobility, in consideration of mobility of the UE.

The disclosure relates to a method of restricting a satellite radio access network (RAN) usage service or using a general 5G RAN due to several reasons (due to a restriction on a user group capable of using a satellite RAN, a restriction on user rights, a change in user subscription, a change in an operator network configuration, and the like) despite that a satellite RAN service is physically available because a UE is in a satellite RAN serviceable area, when an operator includes both a satellite RAN and a general RAN in a same public land mobile network (PLMN), i.e., mobile country codes (MCC) and mobile network codes (MNC).

The disclosure relates to a method of restricting a satellite RAN usage service despite that a satellite RAN service is physically available because a UE is in a satellite RAN serviceable area, when an operator includes both a satellite RAN and a general RAN in a same PLMN, for not only in a home network, but also in a serving network and a visited network, i.e., a visited PLMN (VPLNM), where the UE is on roaming.

The disclosure relates to a method of restricting a satellite RAN usage service or using a general 5G RAN without providing a satellite RAN, for each UE.

According to a method and apparatus of the disclosure, when a UE moves and changes its location, the UE receiving a service by a satellite RAN and a 5G cellular RAN with greater coverage than a 5G cell or a long-term evolution (LTE) cell, mobility management of the UE may be successfully performed in relation to mobility of the UE.

Hereinafter, a method and apparatus for controlling a UE, an access and mobility management function (AMF), and the like, which communicate with a satellite RAN and a cellular network, will be described.

Hereinafter, an embodiment of the disclosure will be described with reference to accompanying drawings. While describing an embodiment of the disclosure, technical content that is well-known in the art and not directly related to the disclosure will not be provided. By omitting the unnecessary description, the gist of the disclosure may be more clearly conveyed without obscuring the subject matter.

For the same reasons, some elements are exaggerated, omitted, or schematically illustrated in drawings. Also, the size of each component does not completely reflect the actual size. In the drawings, like elements are denoted by like reference numerals.

The advantages and features of the disclosure and methods of achieving them will become apparent with reference to embodiments of the disclosure described in detail below with reference to the accompanying drawings. In this regard, the embodiments of the disclosure may have different forms and should not be construed as being limited to the descriptions set forth herein. Rather, these embodiments of the disclosure are provided so that the disclosure will be thorough and complete and will fully convey the concept of the disclosure to one of ordinary skill in the art, and the disclosure will only be defined by the appended claims. Throughout the specification, like reference numerals denote like elements.

It will be understood that blocks in flowcharts or combinations of the flowcharts may be performed by computer program instructions.

In addition, each block may represent a portion of a module, segment, or code that includes one or more executable instructions for executing specified logical function(s). It should also be noted that in some alternative implementations, functions mentioned in blocks may occur out of order. For example, two blocks shown in succession may in fact be executed substantially concurrently or the blocks may sometimes be executed in the reverse order, depending upon the functionality involved.

As used herein, the term “unit” denotes a software element or a hardware element such as a field-programmable gate array (FPGA) or an application-specific integrated circuit (ASIC), and performs a certain function. However, the term “unit” or “-er/or” is not limited to software or hardware. The “unit” or “-er/or” may be formed so as to be in an addressable storage medium, or may be formed so as to operate one or more processors. Thus, for example, the term “unit” or “-er/or” may refer to components such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “units” or “-ers/ors” may be associated with the smaller number of components and “units” or “-ers/ors”, or may be divided into additional components and “units” “-ers/ors”. Furthermore, the components and “units” or “-ers/ors” may be embodied to reproduce one or more central processing units (CPUs) in a device or security multimedia card. Also, in an embodiment of the disclosure, the “unit” or “-er/or” may include at least one processor.

The expression “at least one of A, B, or C” indicates only A, only B, only C, both A and B, both A and C, both B and C, and all of A, B, and C, or variations thereof.

Also, terms for identifying access nodes, terms denoting network entities, terms denoting messages, terms denoting interfaces between network entities, terms denoting various types of identification information, etc. used herein are exemplified for convenience of description. Thus, the terms used in the disclosure are not limited and other terms denoting targets having the same technical meanings may be used.

Hereinafter, for convenience of description, the disclosure uses terms and names defined by the 3rd generation partnership project long term evolution (3GPP LTE) standard or 3GPP new radio (NR) standard, or terms and names modified based thereon. However, the disclosure is not limited by such terms and names, and may be equally applied to systems conforming to other standards. In the disclosure, a base station is an entity that assigns resources to a UE, and may be at least one of a gNode B, a gNB, a eNode B, an eNB, a node B, a BS, an RAN, a next generation-RAN (NG-RAN), a satellite-RAN, a base station controller, or a node on a network. The base station may provide a network access from an LTE system or an NR system to UE(s). For convenience of description, an eNB and a gNB may be interchangeably used. In other words, a base station described as an eNB may also indicate a gNB. In the disclosure, the term “UE” may indicate not only mobile phones, narrow band-Internet of things (NB-IoT) devices, and sensors, but also various wireless communication devices.

In other words, while describing the embodiments of the disclosure in detail, a main target is a communication standard defined by 3GPP, but an important gist of the disclosure may be applied, with a slight modification, to other communication systems having a similar technical background, within a range not greatly departing from the scope of the disclosure, and the applicability would be determined by one of ordinary skill in the art.

In 5G or NR systems, an access and mobility management function (AMF) that is a management entity configured to manage mobility of a UE and a session management function (SMF) that is an entity configured to manage a session are separate. Accordingly, unlike 4th generation (4G) LTE communication systems where a mobility management entity (MME) performs mobility management and session management together, an entity configured to perform mobility management and session management is separated into an AMF and an SMF in 5G or NR systems, and thus, a communication method and communication management method between a UE and a network entity have changed.

In 5G or NR systems, with respect to non 3GPP access, mobility management is performed by an AMF and session management is performed by an SMF via Non-3GPP Inter Working Function (N3IWF). Also, security-related information that is an important factor in the mobility management may also be handled via the AMF.

When satellite communication is used in a mobility situation of a UE, coverage of a satellite covers variously depending on a type of the satellite unlike a cell (or a small cell) of a general 5G NR, and thus, a method of processing mobility of the UE is required.

In a 5G cell or LTE cell, an area covered by a base station of a 5G NR or LTE is limited. Accordingly, an AMF or an MME determined a location of a UE, based on a 5G NR base station or an LTE base station, and determined a last visited tracking area (TA) of the UE when the UE performs a registration request. However, as a satellite has been introduced to 5G as an access type, a range covered by a cell has increased to hundreds of kilometers and to tens of thousands of kilometers depending on a type of the satellite. As shown in FIG. 1, a range of a satellite RAN accessed by a UE may cover a large area including one country and even a neighboring country.

FIG. 1 illustrates a UE and network environment for wireless communication in an environment where 5G communication and satellite communication are supported, according to an embodiment of the disclosure.

Referring to FIG. 1, a 5G or NR core network may include network functions (NFs) such as a user plane function (UPF) 131, an SMF 121, an AMF 111, a 5G RAN 103, a unified data management (UDM) 151, a policy control function (PCF) 161, and the like. To authenticate such entities, entities such as an authentication server function (AUSF) 141 and authentication, authorization and accounting (AAA) 171 may also be included in the 5G or NR core network.

The AMF 111 is an entity configured to manage an access and mobility of a UE 101. For example, the AMF 111 may perform NFs, such as registration, connection, reachability, mobility management, access identification, authentication, and mobility event generation, for the UE 101.

The SMF 121 may be configured to perform a management function for a protocol data unit (PDU) session of the UE 101. For example, the SMF 121 may perform NFS, such as session management functions of establishing, modifying, and releasing a session and maintaining a tunnel between the UPF 131 and the 5G RAN 103 therefor, functions of assigning and managing an Internet protocol (IP) address of the UE 101, user plane selection and control, traffic processing control in the UPF 131, and billing data collection control.

The UPF 131 performs a function of processing data of the UE 101 and may perform a function of processing data such that data transmitted by the UE 101 is transmitted to an external network or data introduced from the external network is transmitted to the UE 101. For example, the UPF 131 may perform NFs, such as a role of an anchor between radio access technologies (RATs), packet routing and forwarding, packet inspection, UPF application, traffic usage report preparation, and buffering.

The UDM 151 may perform functions, such as generation of authentication information for 3GPP security, processing of user identifier (ID), management of list of NFs supporting the UE 101, and subscription information management.

The PCF 161 is an NF configured to manage operator policy information for providing a service in a 5G system.

The UE (user equipment or a terminal) 101 may access a network through the 5G RAN 103 or a satellite RAN. Meanwhile, there may be an N3 interworking function (N3IWF) for a case where a UE communicates through a non 3GPP access. When communicating through the non 3GPP access, session management may be controlled by the UE 101, the non 3GPP access, the N3IWF, and the SMF 121, and mobility management of the non 3GPP access may be controlled by the UE 101, the non 3GPP access, the N3IWF, and the AMF 111.

As described above, in a 4G LTE system, an MME is in charge of both mobility management and session management. In the 5G system, an entity configured to perform mobility management and session management is divided into the AMF 111 and the SMF 121. In the 5G system, a stand-alone (SA) deployment structure in which communication is performed by using only 5G entities, and a non-SA deployment structure in which a 4G entity and a 5G entities are used together, are considered.

As shown in FIG. 1, when the UE 101 communicates with the network, deployment in which the UE 101 is controlled by base stations 103 (i.e., the 5G RAN) and 104 and a 5G network entity of a core network is used may be possible. In this case, mobility management between the UE 101 and the AMF 111, and the session management between the UE 101 and the SMF 121 may be performed by a non-access stratum (NAS) layer called layer 3.

A communication network on which the disclosure is based assumes a 5G NR or 4G LTE network, but a same concept may be applied to other systems within the scope that may be understood by one of ordinary skill in the art.

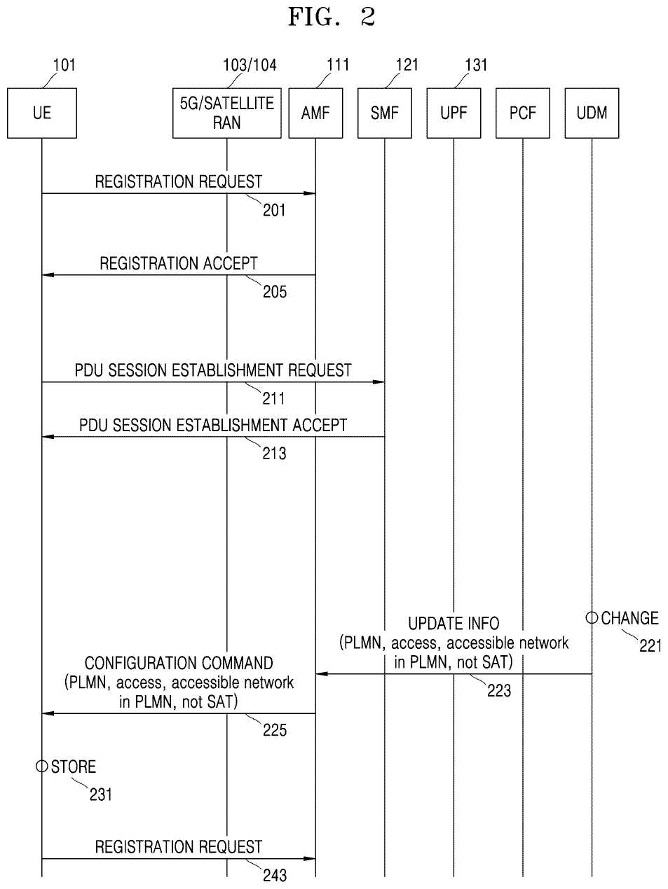

FIG. 2 illustrates a flowchart of a procedure for performing communication in an environment where 5G communication and satellite communication are supported, according to an embodiment of the disclosure.

FIG. 2 illustrates an operating method of a UE when the UE is unable to use a satellite RAN despite that the UE has capability to use the satellite RAN, in a case where the UE is in a home PLMN (HPLMN), wherein the satellite RAN and a general 5G RAN both belong to a PLMN.

The operating method according to an embodiment of the disclosure may include updating information included in the UE through a configuration command message.

In operation 201, the UE transmits a registration request message to the AMF.

In operation 205, the AMF transmits a registration accept message to the UE.

In operation 211, the UE transmits a PDU session establishment request message to the SMF.

In operation 213, the SMF transmits a PDU session establishment accept message to the UE.

In operation 221, with respect to using of a satellite RAN, a change may occur in a UDM, in relation to an operator network or the using of the satellite RAN in the operator network, or in relation to a user group or a user. In this case, the UDM may change details and store the changed details. Alternatively, when subscription of the UE is changed in relation to the using of the satellite RAN, the UDM may change related details and store the changed details.

Then, in operations 223 and 225, the UDM changes authority of the UE through the AMF. To change information about whether the UE is able to use the satellite RAN, the UDM updates UE-related information for the AMF.

Pieces of information updated at this time may be as follows.

Case 1) This is an embodiment of the disclosure related to a method of transmitting information about a PLMN available to a UE and access information available in the PLMN, and a method of transmitting, from a network to a UE, information for restricting the use of a satellite RAN or information for allowing the use of a satellite RAN, and pieces of information being updated are as follows.

1-1) PLMN information available to the UE

1-2) Access information available to the UE

The access information may include information about whether an available RAN is a 5G RAN, a satellite RAN, or a non 3GPP access.

1-3) Accessible network in PLMN information

Information about a network accessible in a PLMN (the accessible network in PLMN information) may include information about whether a RAN available in the PLMN is a 5G RAN, a satellite RAN, or a non 3GPP access. An example of the accessible network in PLMN information may be a combination of a PLMN and a RAN (a 5G RAN, a satellite RAN, or a non 3GPP access). For example, there may be a combination of PLMN #1-5G RAN #1, PLMN #1-satellite RAN #1, or according to an embodiment of the disclosure, PLMN #1-5G RAN #1, 5G RAN #2, 5G RAN #3, satellite RAN #1, but the combination is not limited thereto.

1-4) An indicator, bit, or information element indicating not satellite RAN may be transmitted.

1-4-1) For example, when the indicator indicating not satellite RAN is transmitted together with the accessible network in PLMN information, even when the UE has selected a specific PLMN from a list of 5G RANs, a list of satellite RANs, and a list of PLMNs included in the accessible network in PLMN, the UE may attempt to access only a general 5G RAN instead of a satellite RAN in the specific PLMN, based on information about the bit, information element, or indicator indicating to access only the general 5G RAN instead of the satellite RAN in the specific PLMN. However, the disclosure is not limited thereto.

1-4-2) According to an embodiment of the disclosure, the indicator, bit, or information element indicating not satellite RAN may be transmitted through an NAS message transmitted from an AMF to the UE.

1-4-3) According to an embodiment of the disclosure, the indicator, bit, or information element indicating not satellite RAN may be transmitted through an ng-AP message transmitted from the AMF to a RAN (5G RAN, satellite RAN). Information transmitted to the RAN (5G RAN, satellite RAN) as such may then be transmitted to the UE through a radio resource control (RRC) message.

1-4-4) Such information about not satellite RAN may be applied variably, restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

1-5) According to an embodiment of the disclosure, an indicator, bit, or information element indicating availability of a satellite RAN may be transmitted.

1-5-1) For example, when the indicator indicating the availability of a satellite RAN is transmitted together with the accessible network in PLMN information, even when the UE has selected a specific PLMN from the list of 5G RANs, the list of satellite RANs, and the list of PLMNs included in the accessible network in PLMN, the UE may attempt to access only the satellite RAN or the satellite RAN first in the specific PLMN, based on information about the bit, information element, or indicator indicating to access only the satellite RAN or the satellite RAN first in the specific PLMN. However, the disclosure is not limited thereto.

1-5-2) According to an embodiment of the disclosure, the indicator, bit, or information element indicating the availability of a satellite RAN may be transmitted through an NAS message transmitted from the AMF to the UE.

1-5-3) According to an embodiment of the disclosure, the indicator, bit, or information element indicating the availability of a satellite RAN may be transmitted through an ng-AP message transmitted from the AMF to the RAN (5G RAN, satellite RAN). Information transmitted to the RAN (5G RAN, satellite RAN) as such may then be transmitted to the UE through the RRC message.

1-5-4) Such information about the availability of a satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

In operation 225, the AMF changes information about whether the UE is able to use a satellite RAN via a configuration update message to the UE.

Pieces of information updated at this time and transmitting methods may be as follows.

Case 1) A method of transmitting information about a PLMN available to a UE and access information available in the PLMN, a method of transmitting, from a network to a UE, information for restricting the use of a satellite RAN or information allowed to be used by a satellite RAN.

1-1) PLMN information available to the UE

1-2) Access information available to the UE

The access information may include information about whether an available RAN is a 5G RAN, a satellite RAN, or a non 3GPP access.

1-3) Accessible network in PLMN information

The accessible network in PLMN information may include information about whether an available RAN in corresponding PLMNs is a 5G RAN, a satellite RAN, or a non 3GPP access. According to an embodiment of the disclosure, the accessible network in PLMN information may be a combination of a PLMN and a RAN (5G RAN, satellite RAN, or non 3GPP access). For example, there may be a combination of PLMN #1-5G RAN #1, PLMN #1-satellite RAN #1, or according to an embodiment of the disclosure, PLMN #1-5G RAN #1, 5G RAN #2, 5G RAN #3, satellite RAN #1, but the combination is not limited thereto.

1-4) An indicator, bit, or information element indicating not satellite RAN may be transmitted.

1-4-1) For example, when the indicator indicating not satellite RAN is transmitted together with the accessible network in PLMN information, even when the UE has selected a specific PLMN from a list of 5G RANs, a list of satellite RANs, and a list of PLMNs included in the accessible network in PLMN, the UE may attempt to access only a general 5G RAN instead of a satellite RAN in the specific PLMN, based on information about the bit, information element, or indicator indicating to access only the general 5G RAN instead of the satellite RAN in the specific PLMN. However, the disclosure is not limited thereto.

1-4-2) According to an embodiment of the disclosure, the indicator, bit, or information element indicating not satellite RAN may be transmitted through an NAS message transmitted from an AMF to the UE.

1-4-3) According to an embodiment of the disclosure, the indicator, bit, or information element indicating not satellite RAN may be transmitted through an ng-AP message transmitted from the AMF to a RAN (5G RAN or satellite RAN). Information transmitted to the RAN (5G RAN or satellite RAN) as such may then be transmitted to the UE through an RRC message.

1-4-4) Such information about not satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

In particular, when an occurred change applies a temporal constraint, i.e., a temporal or time restriction, to the UE, timer information may be transmitted to restrict use of a satellite by the UE.

1-5) According to an embodiment of the disclosure, an indicator, bit, or information element indicating availability of a satellite RAN may be transmitted.

1-5-1) For example, when the indicator indicating the availability of a satellite RAN is transmitted together with the accessible network in PLMN information, even when the UE has selected a specific PLMN from the list of 5G RANs, the list of satellite RANs, and the list of PLMNs included in the accessible network in PLMN information ( [symbol] ), the UE may attempt to access only the satellite RAN or the satellite RAN first in the specific PLMN, based on information about the bit, information element, or indicator indicating to access only the satellite RAN or the satellite RAN first in the specific PLMN. However, the disclosure is not limited thereto.

1-5-2) According to an embodiment of the disclosure, the indicator, bit, or information element indicating the availability of a satellite RAN may be transmitted through an NAS message transmitted from the AMF to the UE.

1-5-3) According to an embodiment of the disclosure, the indicator, bit, or information element indicating the availability of a satellite RAN may be transmitted through an ng-AP message transmitted from the AMF to the RAN (5G RAN or satellite RAN). Information transmitted to the RAN (5G RAN or satellite RAN) as such may then be transmitted to the UE through an RRC message.

1-5-4) Such information about the availability of a satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

In particular, when an occurred change applies a temporal constraint, i.e., a temporal or time restriction, to the UE, timer information may be transmitted to allow use of a satellite by the UE.

In operation 231, the UE stores received pieces of information.

The stored information may be used for UE registration and connection using information corresponding to a following registration request, service request and the like at the UE.

Pieces of information stored at this time may be as follows.

Case 1) Information about a PLMN available to a UE and access information available in the PLMN, information for restricting the use of a satellite RAN, or information allowed to be used by a satellite RAN may be stored.

1-1) PLMN information available to the UE

1-2) Access information available to the UE

The access information may include information about whether an available RAN is a 5G RAN, a satellite RAN, or a non 3GPP access.

1-3) Accessible network in PLMN information

The accessible network in PLMN information may include information about whether an available RAN in corresponding PLMNs is a 5G RAN, a satellite RAN, or a non 3GPP access. According to an embodiment of the disclosure, the accessible network in PLMN information may be a combination of a PLMN and a RAN (5G RAN, satellite RAN, or non 3GPP access). For example, there may be a combination of PLMN #1-5G RAN #1, PLMN #1-satellite RAN #1, or according to an embodiment of the disclosure, PLMN #1-5G RAN #1, 5G RAN #2, 5G RAN #3, satellite RAN #1, but the combination is not limited thereto.

1-4) Information about an indicator, bit, or information element indicating not satellite RAN

1-4-1) For example, when the indicator indicating not satellite RAN is received together with the accessible network in PLMN information, even when the UE has selected a specific PLMN from a list of 5G RANs, a list of satellite RANs, and a list of PLMNs included in the accessible network in PLMN, the UE may attempt to access only a general 5G RAN instead of a satellite RAN in the specific PLMN, based on information about the bit, information element, or indicator indicating to access only the general 5G RAN instead of the satellite RAN in the specific PLMN. However, the disclosure is not limited thereto.

1-4-4) Such information about not satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

The UE stores received information and performs a registration request or connection management such as a service request of the UE.

In particular, when an occurred change applies a temporal constraint, i.e., a temporal or time restriction, to the UE, use of a satellite by the UE may be restricted based on received timer information.

1-5) According to an embodiment of the disclosure, information about an indicator, bit, or information element indicating availability of a satellite RAN

1-5-1) For example, when the indicator indicating the availability of a satellite RAN is transmitted together with the accessible network in PLMN information, even when the UE has selected a specific PLMN from the list of 5G RANs, the list of satellite RANs, and the list of PLMNs included in the accessible network in PLMN, the UE may attempt to access only the satellite RAN or the satellite RAN first in the specific PLMN, based on information about the bit, information element, or indicator indicating to access only the satellite RAN or the satellite RAN first in the specific PLMN. However, the disclosure is not limited thereto.

1-5-4) Such information about the availability of a satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

The UE stores received information and performs a registration request or connection management such as a service request of the UE.

In particular, when an occurred change applies a temporal constraint, i.e., a temporal or time restriction, to the UE, use of a satellite by the UE may be allowed based on received timer information.

Then, in operation 243, the UE may transmit a registration request message by accessing a network and a PLMN through a general 5G RAN instead of a satellite RAN.

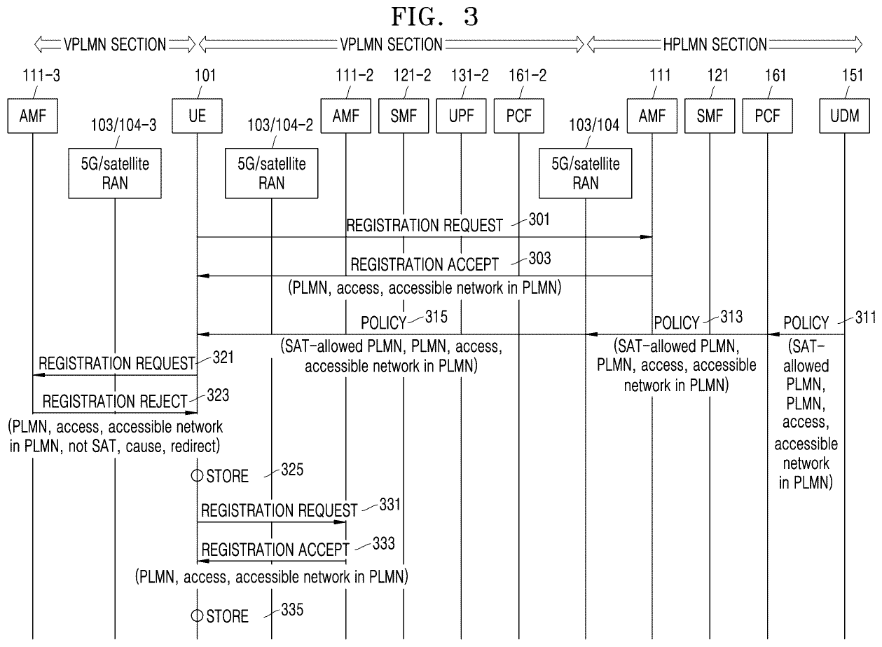

FIG. 3 illustrates a flowchart of a procedure for performing communication in an environment where 5G communication and satellite communication are supported, according to an embodiment of the disclosure.

FIG. 3 illustrates an operating method of a UE when the UE is unable to use a satellite RAN despite that the UE has capability to use the satellite RAN, in a case where the UE has moved to a visited PLMN (VPLMN) and the satellite RAN and a general 5G RAN both belong to a PLMN.

In the operating method according to an embodiment of the disclosure, information may be transmitted to the UE through a registration reject/registration accept message.

An embodiment of the disclosure where the UE is no longer able to use the satellite RAN in the VPLMN may include several following cases.

A change with respect to using of a satellite RAN may occur in relation to an operator network or the using of the satellite RAN in the operator network, or a change with respect to using of a satellite RAN may occur for a user group or a user. Alternatively, according to an embodiment of the disclosure, a change in subscription of a UE may occur in relation to the using of the satellite RAN.

In other words, the change in subscription may occur by a subscription change, a policy of a country to which the UE has moved, or a roaming policy of the roaming operator to which the UE has moved, which does not allow the use of a satellite RAN for the UE that has accessed a network through roaming. In particular, a roaming user, i.e., an inbound user, may be restricted from using a satellite RAN due to an embodiment of the disclosure where, when use of a satellite RAN is not allowed for a UE that has accessed a network through roaming, a local subscriber of a corresponding region is allowed to use the satellite RAN but a user who has accessed the network through roaming, i.e., the inbound user, is restricted from using the satellite RAN.

Operations 301 to 305 are processes in which the UE pre-receives even information about a VPLMN to be used afterwards when accessing an HPLMN. Then with such information, the UE may select an available VPLMN.

Then, operations 321 and 323 and operations 331 and 333 are processes in which the UE receives information by accessing the VPLMN.

In operation 301, the UE transmits a registration request message to the AMF.

In operation 305, the AMF transmits a registration accept message to the UE. The registration accept message may be transmitted while including following pieces of information.

The pieces of information transmitted at this time may be as follows.

Case 1) A method of transmitting information about a PLMN available to a UE and access information available in the PLMN, and a method of transmitting, from a network to a UE, information for restricting the use of a satellite RAN or information allowed to be used by a satellite RAN.

1-1) PLMN information available to the UE

1-2) Access information available to the UE

The access information may include information about whether an available RAN is a 5G RAN, a satellite RAN, or a non 3GPP access.

1-3) Accessible network in PLMN information

The accessible network in PLMN information may include information about whether an available RAN in corresponding PLMNs is a 5G RAN, a satellite RAN, or a non 3GPP access. According to an embodiment of the disclosure, the accessible network in PLMN information may be a combination of a PLMN and a RAN (5G RAN, satellite RAN, or non 3GPP access). For example, there may be a combination of PLMN #1-5G RAN #1, PLMN #1-satellite RAN #1, or according to an embodiment of the disclosure, PLMN #1-5G RAN #1, 5G RAN #2, 5G RAN #3, satellite RAN #1, but the combination is not limited thereto.

1-4) An indicator, bit, or information element indicating not satellite RAN may be transmitted.

1-4-1) For example, when the indicator indicating not satellite RAN is transmitted together with the accessible network in PLMN information, even when the UE has selected a specific PLMN from a list of 5G RANs, a list of satellite RANs, and a list of PLMNs included in the accessible network in PLMN, the UE may attempt to access only a general 5G RAN instead of a satellite RAN in the specific PLMN, based on information about the bit, information element, or indicator indicating to access only the general 5G RAN instead of the satellite RAN in the specific PLMN. However, the disclosure is not limited thereto.

1-4-2) According to an embodiment of the disclosure, the indicator, bit, or information element indicating not satellite RAN may be transmitted through an NAS message transmitted from an AMF to the UE.

1-4-3) According to an embodiment of the disclosure, the indicator, bit, or information element indicating not satellite RAN may be transmitted through an ng-AP message transmitted from the AMF to a RAN (5G RAN, satellite RAN). Information transmitted to the RAN (5G RAN or satellite RAN) as such may then be transmitted to the UE through an RRC message.

1-4-4) Such information about not satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

1-5) According to an embodiment of the disclosure, an indicator, bit, or information element indicating availability of a satellite RAN may be transmitted.

1-5-1) For example, when the indicator indicating the availability of a satellite RAN is transmitted together with the accessible network in PLMN information, even when the UE has selected a specific PLMN from the list of 5G RANs, the list of satellite RANs, and the list of PLMNs included in the accessible network in PLMN, the UE may attempt to access only the satellite RAN or the satellite RAN first in the specific PLMN, based on information about the bit, information element, or indicator indicating to access only the satellite RAN or the satellite RAN first in the specific PLMN. However, the disclosure is not limited thereto.

1-5-2) According to an embodiment of the disclosure, the indicator, bit, or information element indicating the availability of a satellite RAN may be transmitted through an NAS message transmitted from the AMF to the UE.

1-5-3) According to an embodiment of the disclosure, the indicator, bit, or information element indicating the availability of a satellite RAN may be transmitted through an ng-AP message transmitted from the AMF to the RAN (5G RAN, satellite RAN). Information transmitted to the RAN (5G RAN or satellite RAN) as such may then be transmitted to the UE through an RRC message.

1-5-4) Such information about the availability of a satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

Following pieces of information are transmitted in operations 311, 313, and 315.

With respect to using of a satellite RAN, a change may occur in a UDM, in relation to an operator network or the using of the satellite RAN in the operator network, or in relation to a user group or a user. In this case, the UDM may change details and store the changed details. Alternatively, when subscription of the UE is changed in relation to the using of the satellite RAN, the UDM may change related details and store the changed details.

Information about the availability of a satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

In operation 311, the UDM transmits policy information to the PCF.

In operation 313, the PCF transmits the policy information to the AMF.

In operation 315, the AMF transmits the policy information to the UE.

Pieces of information transmitted in operations 311 to 315 are as follows.

Following pieces of information may be transmitted according to an embodiment of the disclosure.

Satellite allowed PLMN information may be transmitted. In other words, information about PLMNs in which use of a satellite RAN is allowed may be transmitted. The information may be about PLMNs in which use of a satellite RAN is allowed in a home network or about PLMNs in which use of a satellite RAN is allowed in a visited network.

Alternatively, satellite not allowed PLMN information may be transmitted. In other words, information about PLMNs in which use of a satellite RAN is not allowed may be transmitted. The information may be about PLMNs in which use of a satellite RAN is not allowed in a home network or about PLMNs in which use of a satellite RAN is not allowed in a visited network.

Following pieces of information may also be transmitted according to an embodiment of the disclosure.

Case 1) A method of transmitting information about a PLMN available to a UE and access information available in the PLMN, and a method of transmitting, from a network to a UE, information for restricting the use of a satellite RAN or information allowed to be used by a satellite RAN.

1-1) PLMN information available to the UE

1-2) Access information available to the UE

The access information may include information about whether an available RAN is a 5G RAN, a satellite RAN, or a non 3GPP access.

1-3) Accessible network in PLMN information

The accessible network in PLMN information may include information about whether an available RAN in corresponding PLMNs is a 5G RAN, a satellite RAN, or a non 3GPP access. According to an embodiment of the disclosure, the accessible network in PLMN information may be a combination of a PLMN and a RAN (5G RAN, satellite RAN, or non 3GPP access). For example, there may be a combination of PLMN #1-5G RAN #1, PLMN #1-satellite RAN #1, or according to an embodiment of the disclosure, PLMN #1-5G RAN #1, 5G RAN #2, 5G RAN #3, satellite RAN #1, but the combination is not limited thereto.

1-4) An indicator, bit, or information element indicating not satellite RAN may be transmitted.

1-4-1) For example, when the indicator indicating not satellite RAN is transmitted together with the accessible network in PLMN information, even when the UE has selected a specific PLMN from a list of 5G RANs, a list of satellite RANs, and a list of PLMNs included in the accessible network in PLMN, the UE may attempt to access only a general 5G RAN instead of a satellite RAN in the specific PLMN, based on information about the bit, information element, or indicator indicating to access only the general 5G RAN instead of the satellite RAN in the specific PLMN. However, the disclosure is not limited thereto.

1-4-2) According to an embodiment of the disclosure, the indicator, bit, or information element indicating not satellite RAN may be transmitted through an NAS message transmitted from an AMF to the UE.

1-4-3) According to an embodiment of the disclosure, the indicator, bit, or information element indicating not satellite RAN may be transmitted through an ng-AP message transmitted from the AMF to a RAN (5G RAN, satellite RAN). Information transmitted to the RAN (5G RAN, satellite RAN) as such may then be transmitted to the UE through an RRC message.

1-4-4) Such information about not satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

1-5) According to an embodiment of the disclosure, an indicator, bit, or information element indicating availability of a satellite RAN may be transmitted.

1-5-1) For example, when the indicator indicating the availability of a satellite RAN is transmitted together with the accessible network in PLMN information, even when the UE has selected a specific PLMN from the list of 5G RANs, the list of satellite RANs, and the list of PLMNs included in the accessible network in PLMN, the UE may attempt to access only the satellite RAN or the satellite RAN first in the specific PLMN, based on information about the bit, information element, or indicator indicating to access only the satellite RAN or the satellite RAN first in the specific PLMN. However, the disclosure is not limited thereto.

1-5-2) According to an embodiment of the disclosure, the indicator, bit, or information element indicating the availability of a satellite RAN may be transmitted through an NAS message transmitted from the AMF to the UE.

1-5-3) According to an embodiment of the disclosure, the indicator, bit, or information element indicating the availability of a satellite RAN may be transmitted through an ng-AP message transmitted from the AMF to the RAN (5G RAN, satellite RAN). Information transmitted to the RAN (5G RAN, satellite RAN) as such may then be transmitted to the UE through an RRC message.

1-5-4) Such information about the availability of a satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

Then, when the UE moves to the VPLMN, a registration procedure is performed as in operations 321 and 323 or in operations 331 and 333.

Operations 321 and 323 are an embodiment of the disclosure about a case where the UE receives, through registration reject from the VPLMN, information about whether the use of a satellite RAN is allowed when accessing a PLMN, and operations 331 and 333 are an embodiment of the disclosure about a case where the UE receives, through registration accept from the VPLMN, information about whether the use of a satellite RAN is allowed when accessing a PLMN.

In operation 321, the UE transmits a registration request message to the AMF.

In operation 323, the AMF transmits a registration reject message to the UE.

Pieces of information transmitted at this time may be as follows.

Case 1) A method of transmitting information about a PLMN available to a UE and access information available in the PLMN, and a method of transmitting, from a network to a UE, information for restricting the use of a satellite RAN or information allowed to be used by a satellite RAN.

1-1) PLMN information available to the UE

1-2) Access information available to the UE

The access information may include information about whether an available RAN is a 5G RAN, a satellite RAN, or a non 3GPP access.

1-3) Accessible network in PLMN information

The accessible network in PLMN information may include information about whether an available RAN in corresponding PLMNs is a 5G RAN, a satellite RAN, or a non 3GPP access. According to an embodiment of the disclosure, the accessible network in PLMN information may be a combination of a PLMN and a RAN (5G RAN, satellite RAN, or non 3GPP access). For example, there may be a combination of PLMN #1-5G RAN #1, PLMN #1-satellite RAN #1, or according to an embodiment of the disclosure, PLMN #1-5G RAN #1, 5G RAN #2, 5G RAN #3, satellite RAN #1, but the combination is not limited thereto.

1-4) An indicator, bit, or information element indicating not satellite RAN may be transmitted.

1-4-1) For example, when the indicator indicating not satellite RAN is transmitted together with the accessible network in PLMN information, even when the UE has selected a specific PLMN from a list of 5G RANs, a list of satellite RANs, and a list of PLMNs included in the accessible network in PLMN, the UE may attempt to access only a general 5G RAN instead of a satellite RAN in the specific PLMN, based on information about the bit, information element, or indicator indicating to access only the general 5G RAN instead of the satellite RAN in the specific PLMN. However, the disclosure is not limited thereto.

1-4-2) According to an embodiment of the disclosure, the indicator, bit, or information element indicating not satellite RAN may be transmitted through an NAS message transmitted from an AMF to the UE.

1-4-3) According to an embodiment of the disclosure, the indicator, bit, or information element indicating not satellite RAN may be transmitted through an ng-AP message transmitted from the AMF to a RAN (5G RAN, satellite RAN). Information transmitted to the RAN (5G RAN, satellite RAN) as such may then be transmitted to the UE through an RRC message.

1-4-4) Such information about not satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

1-5) According to an embodiment of the disclosure, an indicator, bit, or information element indicating availability of a satellite RAN may be transmitted.

1-5-1) For example, when the indicator indicating the availability of a satellite RAN is transmitted together with the accessible network in PLMN information, even when the UE has selected a specific PLMN from the list of 5G RANs, the list of satellite RANs, and the list of PLMNs included in the accessible network in PLMN, the UE may attempt to access only the satellite RAN or the satellite RAN first in the specific PLMN, based on information about the bit, information element, or indicator indicating to access only the satellite RAN or the satellite RAN first in the specific PLMN. However, the disclosure is not limited thereto.

1-5-2) According to an embodiment of the disclosure, the indicator, bit, or information element indicating the availability of a satellite RAN may be transmitted through an NAS message transmitted from the AMF to the UE.

1-5-3) According to an embodiment of the disclosure, the indicator, bit, or information element indicating the availability of a satellite RAN may be transmitted through an ng-AP message transmitted from the AMF to the RAN (5G RAN, satellite RAN). Information transmitted to the RAN (5G RAN, satellite RAN) as such may then be transmitted to the UE through an RRC message.

1-5-4) Such information about the availability of a satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

1-6) Cause information may be transmitted. The cause information may be used to notify that a network access and service through a satellite RAN is not allowed for the UE. When the cause information is received, for case 1) when there is a satellite RAN and a 5G general RAN in a same PLMN, the UE may perform registration in the PLMN through the general RAN instead of the satellite RAN. As for case 2) when there is only a satellite RAN and no general 5G RAN in a PLMN, the UE may perform registration in a PLMN with a general 5G RAN instead of a satellite RAN upon receiving the cause.

1-7) Information about a redirect indicator, bit, information element may be transmitted.

Such redirect information may be information indicating the UE to access a network, in which a satellite access is allowed, in a same PLMN or even in another PLMN because a network access and service through a satellite RAN is not allowed for the UE. According to an embodiment of the disclosure, when there is a general 5G RAN in addition to a satellite RAN in a same PLMN, i.e., when there are both a satellite RAN and a general 5G RAN in a same PLMN, the UE may be indicated to access a network through a general 5G RAN instead of a satellite RAN. Alternatively, when only a satellite RAN is allowed in a PLMN, the UE may be indicated to redirect a network access to a PLMN in which a general 5G RAN is also available, instead of another satellite RAN.

In operation 325, the UE may store received information.

The stored information may be used for UE registration and connection using information corresponding to a following registration request, service request and the like at the UE.

The pieces of information stored at this time may be as follows.

Case 1) Information about a PLMN available to a UE and access information available in the PLMN, information for restricting the use of a satellite RAN, or information allowed to be used by a satellite RAN may be stored.

1-1) PLMN information available to the UE

1-2) Access information available to the UE

The access information may include information about whether an available RAN is a 5G RAN, a satellite RAN, or a non 3GPP access.

1-3) Accessible network in PLMN information

The accessible network in PLMN information may include information about whether an available RAN in corresponding PLMNs is a 5G RAN, a satellite RAN, or a non 3GPP access. According to an embodiment of the disclosure, the accessible network in PLMN information may be a combination of a PLMN and a RAN (5G RAN, satellite RAN, or non 3GPP access). For example, there may be a combination of PLMN #1-5G RAN #1, PLMN #1-satellite RAN #1, or according to an embodiment of the disclosure, PLMN #1-5G RAN #1, 5G RAN #2, 5G RAN #3, satellite RAN #1, but the combination is not limited thereto.

1-4) Information about an indicator, bit, or information element indicating not satellite RAN

1-4-1) For example, when the indicator indicating not satellite RAN is received together with the accessible network in PLMN information, even when the UE has selected a specific PLMN from a list of 5G RANs, a list of satellite RANs, and a list of PLMNs included in the accessible network in PLMN, the UE may attempt to access only a general 5G RAN instead of a satellite RAN in the specific PLMN, based on information about the bit, information element, or indicator indicating to access only the general 5G RAN instead of the satellite RAN in the specific PLMN. However, the disclosure is not limited thereto.

1-4-4) Such information about not satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

The UE stores received information and performs a registration request or connection management such as a service request of the UE.

In particular, when an occurred change applies a temporal constraint, i.e., a temporal or time restriction, to the UE, use of a satellite by the UE may be restricted based on received timer information.

1-5) According to an embodiment of the disclosure, information about an indicator, bit, or information element indicating availability of a satellite RAN

1-5-1) For example, when the indicator indicating the availability of a satellite RAN is transmitted together with the accessible network in PLMN information, even when the UE has selected a specific PLMN from the list of 5G RANs, the list of satellite RANs, and the list of PLMNs included in the accessible network in PLMN, the UE may attempt to access only the satellite RAN or the satellite RAN first in the specific PLMN, based on information about the bit, information element, or indicator indicating to access only the satellite RAN or the satellite RAN first in the specific PLMN. However, the disclosure is not limited thereto.

1-5-4) Such information about the availability of a satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

The UE stores received information and performs a registration request or connection management such as a service request of the UE.

In particular, when an occurred change applies a temporal constraint, i.e., a temporal or time restriction, to the UE, use of a satellite by the UE may be allowed based on received timer information.

In operation 331, the UE transmits a registration request message to the AMF.

In operation 333, the AMF transmits a registration accept message to the UE.

Pieces of information transmitted at this time may be as follows.

Case 1) A method of transmitting information about a PLMN available to a UE and access information available in the PLMN, and a method of transmitting, from a network to a UE, information for restricting the use of a satellite RAN or information allowed to be used by a satellite RAN.

1-1) PLMN information available to the UE

1-2) Access information available to the UE

The access information may include information about whether an available RAN is a 5G RAN, a satellite RAN, or a non 3GPP access.

1-3) Accessible network in PLMN information

The accessible network in PLMN information may include information about whether an available RAN in corresponding PLMNs is a 5G RAN, a satellite RAN, or a non 3GPP access. According to an embodiment of the disclosure, the accessible network in PLMN information may be a combination of a PLMN and a RAN (5G RAN, satellite RAN, or non 3GPP access). For example, there may be a combination of PLMN #1-5G RAN #1, PLMN #1-satellite RAN #1, or according to an embodiment of the disclosure, PLMN #1-5G RAN #1, 5G RAN #2, 5G RAN #3, satellite RAN #1, but the combination is not limited thereto.

1-4) An indicator, bit, or information element indicating not satellite RAN may be transmitted.

1-4-1) For example, when the indicator indicating not satellite RAN is transmitted together with the accessible network in PLMN information, even when the UE has selected a specific PLMN from a list of 5G RANs, a list of satellite RANs, and a list of PLMNs included in the accessible network in PLMN, the UE may attempt to access only a general 5G RAN instead of a satellite RAN in the specific PLMN, based on information about the bit, information element, or indicator indicating to access only the general 5G RAN instead of the satellite RAN in the specific PLMN. However, the disclosure is not limited thereto.

1-4-2) According to an embodiment of the disclosure, the indicator, bit, or information element indicating not satellite RAN may be transmitted through an NAS message transmitted from an AMF to the UE.

1-4-3) According to an embodiment of the disclosure, the indicator, bit, or information element indicating not satellite RAN may be transmitted through an ng-AP message transmitted from the AMF to a RAN (5G RAN, satellite RAN). Information transmitted to the RAN (5G RAN, satellite RAN) as such may then be transmitted to the UE through an RRC message.

1-4-4) Such information about not satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

1-5) According to an embodiment of the disclosure, an indicator, bit, or information element indicating availability of a satellite RAN may be transmitted.

1-5-1) For example, when the indicator indicating the availability of a satellite RAN is transmitted together with the accessible network in PLMN information, even when the UE has selected a specific PLMN from the list of 5G RANs, the list of satellite RANs, and the list of PLMNs included in the accessible network in PLMN, the UE may attempt to access only the satellite RAN or the satellite RAN first in the specific PLMN, based on information about the bit, information element, or indicator indicating to access only the satellite RAN or the satellite RAN first in the specific PLMN. However, the disclosure is not limited thereto.

1-5-2) According to an embodiment of the disclosure, the indicator, bit, or information element indicating the availability of a satellite RAN may be transmitted through an NAS message transmitted from the AMF to the UE.

1-5-3) According to an embodiment of the disclosure, the indicator, bit, or information element indicating the availability of a satellite RAN may be transmitted through an ng-AP message transmitted from the AMF to the RAN (5G RAN, satellite RAN). Information transmitted to the RAN (5G RAN, satellite RAN) as such may then be transmitted to the UE through an RRC message.

1-5-4) Such information about the availability of a satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

In operation 335, the UE stores received information.

The stored information may be used for UE registration and connection using information corresponding to a following registration request, service request and the like at the UE.

The pieces of information stored at this time may be as follows.

Case 1) Information about a PLMN available to a UE and access information available in the PLMN, information for restricting the use of a satellite RAN, or information allowed to be used by a satellite RAN may be stored.

1-1) PLMN information available to the UE

1-2) Access information available to the UE

The access information may include information about whether an available RAN is a 5G RAN, a satellite RAN, or a non 3GPP access.

1-3) Accessible network in PLMN information

The accessible network in PLMN information may include information about whether an available RAN in corresponding PLMNs is a 5G RAN, a satellite RAN, or a non 3GPP access. According to an embodiment of the disclosure, the accessible network in PLMN information may be a combination of a PLMN and a RAN (5G RAN, satellite RAN, or non 3GPP access). For example, there may be a combination of PLMN #1-5G RAN #1, PLMN #1-satellite RAN #1, or according to an embodiment of the disclosure, PLMN #1-5G RAN #1, 5G RAN #2, 5G RAN #3, satellite RAN #1, but the combination is not limited thereto.

1-4) Information about an indicator, bit, or information element indicating not satellite RAN

1-4-1) For example, when the indicator indicating not satellite RAN is received together with the accessible network in PLMN information, even when the UE has selected a specific PLMN from a list of 5G RANs, a list of satellite RANs, and a list of PLMNs included in the accessible network in PLMN, the UE may attempt to access only a general 5G RAN instead of a satellite RAN in the specific PLMN, based on information about the bit, information element, or indicator indicating to access only the general 5G RAN instead of the satellite RAN in the specific PLMN. However, the disclosure is not limited thereto.

1-4-4) Such information about not satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

The UE stores received information and performs a registration request or connection management such as a service request of the UE.

In particular, when an occurred change applies a temporal constraint, i.e., a temporal or time restriction, to the UE, use of a satellite by the UE may be restricted based on received timer information.

1-5) According to an embodiment of the disclosure, information about an indicator, bit, or information element indicating availability of a satellite RAN

1-5-1) For example, when the indicator indicating the availability of a satellite RAN is transmitted together with the accessible network in PLMN information, even when the UE has selected a specific PLMN from the list of 5G RANs, the list of satellite RANs, and the list of PLMNs included in the accessible network in PLMN, the UE may attempt to access only the satellite RAN or the satellite RAN first in the specific PLMN, based on information about the bit, information element, or indicator indicating to access only the satellite RAN or the satellite RAN first in the specific PLMN. However, the disclosure is not limited thereto.

1-5-4) Such information about the availability of a satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

The UE stores received information and performs a registration request or connection management such as a service request of the UE.

In particular, when an occurred change applies a temporal constraint, i.e., a temporal or time restriction, to the UE, use of a satellite by the UE may be allowed based on received timer information.

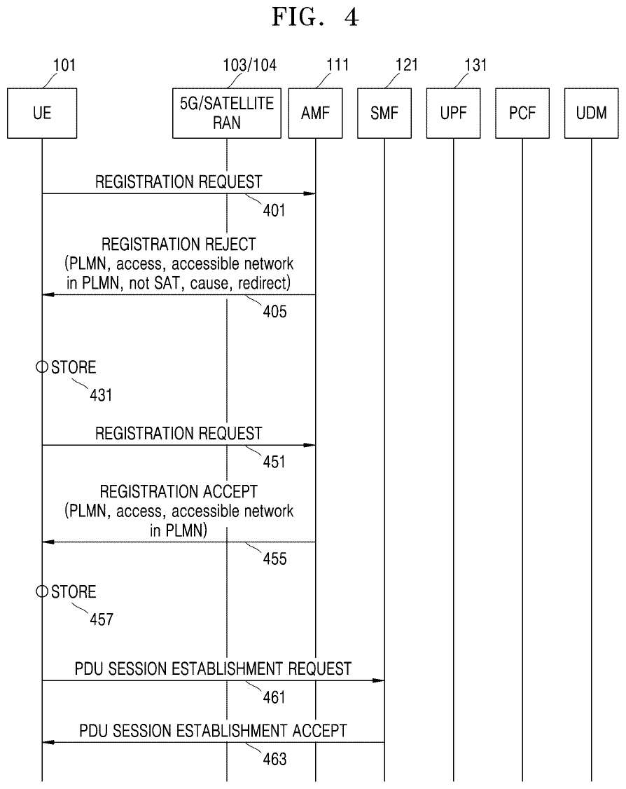

FIG. 4 illustrates a flowchart of a procedure for performing communication in an environment where 5G communication and satellite communication are supported, according to an embodiment of the disclosure.

FIG. 4 illustrates an operating method of a UE when the UE is unable to use a satellite RAN despite that the UE has capability to use the satellite RAN, in a case where the UE is in a home PLMN (HPLMN), wherein the satellite RAN and a general 5G RAN both belong to a PLMN.

In the operating method according to an embodiment of the disclosure, information stored in the UE may be updated through a registration accept/registration reject message. Alternatively, information about a PLMN available to the UE, access information available in the PLMN, information for restricting use of a satellite RAN, or information for allowing use of a satellite RAN may be transmitted from a network to the UE through a registration accept message or a registration reject message.

In operation 401, the UE transmits a registration request message to the AMF.

In operation 405, the AMF transmits a registration accept message to the UE.

Pieces of information transmitted at this time may be as follows.

Case 1) A method of transmitting information about a PLMN available to a UE and access information available in the PLMN, and a method of transmitting, from a network to a UE, information for restricting the use of a satellite RAN or information allowing the use of a satellite RAN.

1-1) PLMN information available to the UE

1-2) Access information available to the UE

The access information may include information about whether an available RAN is a 5G RAN, a satellite RAN, or a non 3GPP access.

1-3) Accessible network in PLMN information

The accessible network in PLMN information may include information about whether an available RAN in corresponding PLMNs is a 5G RAN, a satellite RAN, or a non 3GPP access. According to an embodiment of the disclosure, the accessible network in PLMN information may be a combination of a PLMN and a RAN (5G RAN, satellite RAN, or non 3GPP access). For example, there may be a combination of PLMN #1-5G RAN #1, PLMN #1-satellite RAN #1, or according to an embodiment of the disclosure, PLMN #1-5G RAN #1, 5G RAN #2, 5G RAN #3, satellite RAN #1, but the combination is not limited thereto.

1-4) An indicator, bit, or information element indicating not satellite RAN may be transmitted.

1-4-1) For example, when the indicator indicating not satellite RAN is transmitted together with the accessible network in PLMN information, even when the UE has selected a specific PLMN from a list of 5G RANs, a list of satellite RANs, and a list of PLMNs included in the accessible network in PLMN, the UE may attempt to access only a general 5G RAN instead of a satellite RAN in the specific PLMN, based on information about the bit, information element, or indicator indicating to access only the general 5G RAN instead of the satellite RAN in the specific PLMN. However, the disclosure is not limited thereto.

1-4-2) According to an embodiment of the disclosure, the indicator, bit, or information element indicating not satellite RAN may be transmitted through an NAS message transmitted from an AMF to the UE.

1-4-3) According to an embodiment of the disclosure, the indicator, bit, or information element indicating not satellite RAN may be transmitted through an ng-AP message transmitted from the AMF to a RAN (5G RAN, satellite RAN). Information transmitted to the RAN (5G RAN, satellite RAN) as such may then be transmitted to the UE through an RRC message.

1-4-4) Such information about not satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

1-5) According to an embodiment of the disclosure, an indicator, bit, or information element indicating availability of a satellite RAN may be transmitted.

1-5-1) For example, when the indicator indicating the availability of a satellite RAN is transmitted together with the accessible network in PLMN information, even when the UE has selected a specific PLMN from the list of 5G RANs, the list of satellite RANs, and the list of PLMNs included in the accessible network in PLMN, the UE may attempt to access only the satellite RAN or the satellite RAN first in the specific PLMN, based on information about the bit, information element, or indicator indicating to access only the satellite RAN or the satellite RAN first in the specific PLMN. However, the disclosure is not limited thereto.

1-5-2) According to an embodiment of the disclosure, the indicator, bit, or information element indicating the availability of a satellite RAN may be transmitted through an NAS message transmitted from the AMF to the UE.

1-5-3) According to an embodiment of the disclosure, the indicator, bit, or information element indicating the availability of a satellite RAN may be transmitted through an ng-AP message transmitted from the AMF to the RAN (5G RAN, satellite RAN). Information transmitted to the RAN (5G RAN, satellite RAN) as such may then be transmitted to the UE through an RRC message.

1-5-4) Such information about the availability of a satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

1-6) Cause information may be transmitted. The cause information may be used to notify that a network access and service through a satellite RAN is not allowed for the UE. When the cause information is received, for case 1) when there is a satellite RAN and a 5G general RAN in a same PLMN, the UE may perform registration in the PLMN through the general RAN instead of the satellite RAN. As for case 2) when there is only a satellite RAN and no general 5G RAN in a PLMN, the UE may perform registration in a PLMN with a general 5G RAN instead of a satellite RAN upon receiving the cause.

1-7) Information about a redirect indicator, bit, or information element may be transmitted.

Such redirect information may be information indicating the UE to access a network, in which a satellite access is allowed, in a same PLMN or even in another PLMN because a network access and service through a satellite RAN is not allowed for the UE. According to an embodiment of the disclosure, when there is a general 5G RAN in addition to a satellite RAN in a same PLMN, i.e., when there are both a satellite RAN and a general 5G RAN in a same PLMN, the UE may be indicated to access a network through a general 5G RAN instead of a satellite RAN. Alternatively, when only a satellite RAN is allowed in a PLMN, the UE may be indicated to redirect a network access to a PLMN in which a general 5G RAN is also available, instead of another satellite RAN.

In operation 431, the UE stores received information.

The stored information may be used for UE registration and connection using information corresponding to a following registration request, service request and the like at the UE.

Pieces of information stored at this time may be as follows.

Case 1) Information about a PLMN available to a UE and access information available in the PLMN, information for restricting the use of a satellite RAN, or information allowed to be used by a satellite RAN may be stored.

1-1) PLMN information available to the UE

1-2) Access information available to the UE

The access information may include information about whether an available RAN is a 5G RAN, a satellite RAN, or a non 3GPP access.

1-3) Accessible network in PLMN information

The accessible network in PLMN information may include information about whether an available RAN in corresponding PLMNs is a 5G RAN, a satellite RAN, or a non 3GPP access. According to an embodiment of the disclosure, the accessible network in PLMN information may be a combination of a PLMN and a RAN (5G RAN, satellite RAN, or non 3GPP access). For example, there may be a combination of PLMN #1-5G RAN #1, PLMN #1-satellite RAN #1, or according to an embodiment of the disclosure, PLMN #1-5G RAN #1, 5G RAN #2, 5G RAN #3, satellite RAN #1, but the combination is not limited thereto.

1-4) Information about an indicator, bit, or information element indicating not satellite RAN

1-4-1) For example, when the indicator indicating not satellite RAN is received together with the accessible network in PLMN information, even when the UE has selected a specific PLMN from a list of 5G RANs, a list of satellite RANs, and a list of PLMNs included in the accessible network in PLMN, the UE may attempt to access only a general 5G RAN instead of a satellite RAN in the specific PLMN, based on information about the bit, information element, or indicator indicating to access only the general 5G RAN instead of the satellite RAN in the specific PLMN. However, the disclosure is not limited thereto.

1-4-4) Such information about not satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

The UE stores received information and performs a registration request or connection management such as a service request of the UE.

In particular, when an occurred change applies a temporal constraint, i.e., a temporal or time restriction, to the UE, use of a satellite by the UE may be restricted based on received timer information.

1-5) According to an embodiment of the disclosure, information about an indicator, bit, or information element indicating availability of a satellite RAN

1-5-1) For example, when the indicator indicating the availability of a satellite RAN is transmitted together with the accessible network in PLMN information, even when the UE has selected a specific PLMN from the list of 5G RANs, the list of satellite RANs, and the list of PLMNs included in the accessible network in PLMN, the UE may attempt to access only the satellite RAN or the satellite RAN first in the specific PLMN, based on information about the bit, information element, or indicator indicating to access only the satellite RAN or the satellite RAN first in the specific PLMN. However, the disclosure is not limited thereto.

1-5-4) Such information about the availability of a satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

The UE stores received information and performs a registration request or connection management such as a service request of the UE.

In particular, when an occurred change applies a temporal constraint, i.e., a temporal or time restriction, to the UE, use of a satellite by the UE may be allowed based on received timer information.

In operation 451, the UE transmits a registration request message to the AMF. One AMF is illustrated in FIG. 4, but an AMF accessed by the UE after registration reject may be another AMF. Also, the UE may transmit the registration request message to an AMF (may be another AMF or a same AMF) through a 5G RAN when not SAT is previously received through a registration reject message, the not SAT indicating that an access through a satellite RAN is not allowed.

In operation 455, the AMF transmits a registration accept message to the UE.

Pieces of information transmitted at this time may be as follows.

Case 1) A method of transmitting information about a PLMN available to a UE and access information available in the PLMN, and a method of transmitting, from a network to a UE, information for restricting the use of a satellite RAN or information allowed to be used by a satellite RAN.

1-1) PLMN information available to the UE

1-2) Access information available to the UE

The access information may include information about whether an available RAN is a 5G RAN, a satellite RAN, or a non 3GPP access.

1-3) Accessible network in PLMN information

The accessible network in PLMN information may include information about whether an available RAN in corresponding PLMNs is a 5G RAN, a satellite RAN, or a non 3GPP access. According to an embodiment of the disclosure, the accessible network in PLMN information may be a combination of a PLMN and a RAN (5G RAN, satellite RAN, or non 3GPP access). For example, there may be a combination of PLMN #1-5G RAN #1, PLMN #1-satellite RAN #1, or according to an embodiment of the disclosure, PLMN #1-5G RAN #1, 5G RAN #2, 5G RAN #3, satellite RAN #1, but the combination is not limited thereto.

1-4) An indicator, bit, or information element indicating not satellite RAN may be transmitted.

1-4-1) For example, when the indicator indicating not satellite RAN is transmitted together with the accessible network in PLMN information, even when the UE has selected a specific PLMN from a list of 5G RANs, a list of satellite RANs, and a list of PLMNs included in the accessible network in PLMN, the UE may attempt to access only a general 5G RAN instead of a satellite RAN in the specific PLMN, based on information about the bit, information element, or indicator indicating to access only the general 5G RAN instead of the satellite RAN in the specific PLMN. However, the disclosure is not limited thereto.

1-4-2) According to an embodiment of the disclosure, the indicator, bit, or information element indicating not satellite RAN may be transmitted through an NAS message transmitted from an AMF to the UE.

1-4-3) According to an embodiment of the disclosure, the indicator, bit, or information element indicating not satellite RAN may be transmitted through an ng-AP message transmitted from the AMF to a RAN (5G RAN, satellite RAN). Information transmitted to the RAN (5G RAN, satellite RAN) as such may then be transmitted to the UE through an RRC message.

1-4-4) Such information about not satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

1-5) According to an embodiment of the disclosure, an indicator, bit, or information element indicating availability of a satellite RAN may be transmitted.

1-5-1) For example, when the indicator indicating the availability of a satellite RAN is transmitted together with the accessible network in PLMN information, even when the UE has selected a specific PLMN from the list of 5G RANs, the list of satellite RANs, and the list of PLMNs included in the accessible network in PLMN, the UE may attempt to access only the satellite RAN or the satellite RAN first in the specific PLMN, based on information about the bit, information element, or indicator indicating to access only the satellite RAN or the satellite RAN first in the specific PLMN. However, the disclosure is not limited thereto.

1-5-2) According to an embodiment of the disclosure, the indicator, bit, or information element indicating the availability of a satellite RAN may be transmitted through an NAS message transmitted from the AMF to the UE.

1-5-3) According to an embodiment of the disclosure, the indicator, bit, or information element indicating the availability of a satellite RAN may be transmitted through an ng-AP message transmitted from the AMF to the RAN (5G RAN, satellite RAN). Information transmitted to the RAN (5G RAN, satellite RAN) as such may then be transmitted to the UE through an RRC message.

1-5-4) Such information about the availability of a satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

In operation 457, the UE stores received information.

The stored information may be used for UE registration and connection using information corresponding to a following registration request, service request and the like at the UE.

The pieces of information stored at this time may be as follows.

Case 1) Information about a PLMN available to a UE and access information available in the PLMN, information for restricting the use of a satellite RAN, or information allowed to be used by a satellite RAN may be stored.

1-1) PLMN information available to the UE

1-2) Access information available to the UE

The access information may include information about whether an available RAN is a 5G RAN, a satellite RAN, or a non 3GPP access.

1-3) Accessible network in PLMN information

The accessible network in PLMN information may include information about whether an available RAN in corresponding PLMNs is a 5G RAN, a satellite RAN, or a non 3GPP access. According to an embodiment of the disclosure, the accessible network in PLMN information may be a combination of a PLMN and a RAN (5G RAN, satellite RAN, or non 3GPP access). For example, there may be a combination of PLMN #1-5G RAN #1, PLMN #1-satellite RAN #1, or according to an embodiment of the disclosure, PLMN #1-5G RAN #1, 5G RAN #2, 5G RAN #3, satellite RAN #1, but the combination is not limited thereto.

1-4) Information about an indicator, bit, or information element indicating not satellite RAN

1-4-1) For example, when the indicator indicating not satellite RAN is received together with the accessible network in PLMN information, even when the UE has selected a specific PLMN from a list of 5G RANs, a list of satellite RANs, and a list of PLMNs included in the accessible network in PLMN, the UE may attempt to access only a general 5G RAN instead of a satellite RAN in the specific PLMN, based on information about the bit, information element, or indicator indicating to access only the general 5G RAN instead of the satellite RAN in the specific PLMN. However, the disclosure is not limited thereto.

1-4-4) Such information about not satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

The UE stores received information and performs a registration request or connection management such as a service request of the UE.

In particular, when an occurred change applies a temporal constraint, i.e., a temporal or time restriction, to the UE, use of a satellite by the UE may be restricted based on received timer information.

1-5) According to an embodiment of the disclosure, information about an indicator, bit, or information element indicating availability of a satellite RAN

1-5-1) For example, when the indicator indicating the availability of a satellite RAN is transmitted together with the accessible network in PLMN information, even when the UE has selected a specific PLMN from the list of 5G RANs, the list of satellite RANs, and the list of PLMNs included in the accessible network in PLMN, the UE may attempt to access only the satellite RAN or the satellite RAN first in the specific PLMN, based on information about the bit, information element, or indicator indicating to access only the satellite RAN or the satellite RAN first in the specific PLMN. However, the disclosure is not limited thereto.

1-5-4) Such information about the availability of a satellite RAN may be applied variably or restrictively. In other words, despite that the UE or network has capability to support a satellite RAN and is in a same network due to the reasons of network configuration of the network being changed, law/institution of an operator network, nation, or society being changed, a restriction on an available group being changed, or a restriction for a user flowed in from an overseas country/the outside of a permitted group etc., the information about not satellite RAN may be transmitted to notify the UE at or after a time when such network or UE-related changes occur when the use of satellite RAN needs to be temporarily restricted for a specific user, a user group, or a user flowed in from an overseas country/the outside, when the use of satellite RAN needs to be temporarily restricted with a temporal restriction, or when the use of satellite RAN needs to be restricted after permission in an emergency situation (earthquake or tsunami) and the like.

The UE stores received information and performs a registration request or connection management such as a service request of the UE.

In particular, when an occurred change applies a temporal constraint, i.e., a temporal or time restriction, to the UE, use of a satellite by the UE may be allowed based on received timer information.

In operation 461, the UE transmits a PDU session establishment request message to the SMF.

In operation 463, the SMF transmits a PDU session establishment accept message to the UE.

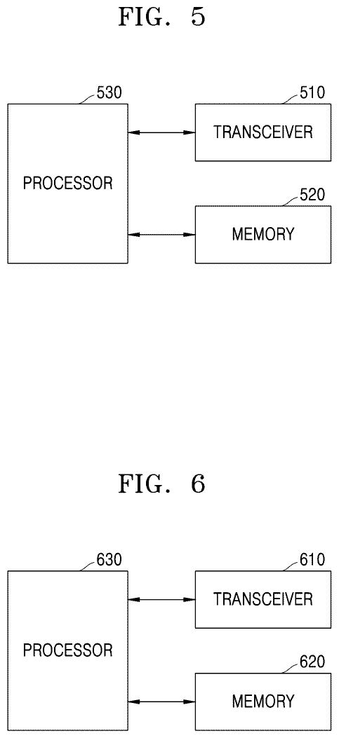

FIG. 5 illustrates a diagram of a configuration of a UE, according to an embodiment of the disclosure.

The UE according to an embodiment of the disclosure may include a transceiver 510, a memory 520, and a processor 530. The processor 530, the transceiver 510, and the memory 520 of the UE may operate according to a communication method of the UE described above. However, the components of the UE are not limited thereto. For example, the UE may include more or fewer components than the components described above. In addition, the processor 530, the transceiver 510, and the memory 520 may be implemented in a single chip.

A receiver of the UE and a transmitter of the UE may be collectively referred to as the transceiver 510, and the transceiver 510 may transmit or receive a signal to or from a base station or various network entities. The signal transmitted or received to or from the base station may include control information and data. In this regard, the transceiver 510 may include a radio frequency (RF) transmitter for up-converting and amplifying a frequency of a transmitted signal, and an RF receiver for low-noise amplifying a received signal and down-converting a frequency. However, this is only an example of the transceiver 510, and the components of the transceiver 510 are not limited to the RF transmitter and RF receiver. Also, the transceiver 510 may include wired/wireless transceiver and may include various components for transmitting and receiving signals. Also, the transceiver 510 may receive a signal through a wireless channel and output the same to the processor 530, and transmit a signal output from the processor 530 through the wireless channel. Also, the transceiver 510 may receive and output a communication signal to the processor and transmit a signal output from the processor to various network entities through a wired/wireless network.

The memory 520 may store at least one program, data, and instruction required for operations of the UE. Furthermore, the memory 520 may store control information or data included in a signal obtained by the UE. The memory 520 may include a storage medium such as read only memory (ROM), random-access memory (RAM), hard disk, compact disk ROM (CD-ROM), and a digital versatile disc (DVD), or a combination of storage media.

The processor 530 may control a series of processes such that the UE operates according to an embodiment of the disclosure described above. Also, the processor 530 may include at least one processor. For example, the processor 530 may include a communication processor (CP) for controlling communications and an application processor (AP) for controlling a higher layer such as an application program.

The processor 530 according to an embodiment of the disclosure may operate according to the embodiments of the disclosure described above.

FIG. 6 illustrates a diagram of a configuration of a network entity, according to an embodiment of the disclosure.

As shown in FIG. 6, the network entity of the disclosure may include a transceiver 610, a memory 620, and a processor 630. The processor 630, the transceiver 610, and the memory 620 of the network entity may operate according to a communication method of the network entity described above. However, the components of the network entity are not limited thereto. For example, the network entity may include more or fewer components than those described above. In addition, the transceiver 610, the memory 620, and the processor 630 may be implemented in a single chip. The network entity may include an NF, such as an AMF, an SMF, a PCF, network exposure function (NEF), a UDM, or a UPF, which is described above. Also, the network entity may include a base station.

A receiver of the network entity and a transmitter of the network entity may be collectively referred to as the transceiver 610, and the transceiver 610 may transmit or receive a signal to or from a UE or another network entity. Here, the transmitted or received signal may include control information and data. In this regard, the transceiver 610 may include an RF transmitter for up-converting the frequency of a signal to be transmitted and amplifying the signal and an RF receiver for low-noise amplifying a received signal and down-converting the frequency of the received signal. However, this is only an example of the transceiver 60, and the components of the transceiver 610 are not limited to the RF transmitter and RF receiver. The transceiver 610 may include wired/wireless transceiver and may include various components for transmitting and receiving signals. Also, the transceiver 610 may receive signals through communication channels (for example, wireless channels) and output the signals to the processor 630, and may transmit signals output from the processor 630, through the communication channels. Also, the transceiver 610 may receive and output a communication signal to the processor and transmit a signal output from the processor to a UE or a network entity through a wired/wireless network.

The memory 620 may store a program and data required for operations of the network entity. Also, the memory 620 may store control information or data included in a signal obtained by the network entity. The memory 620 may include a storage medium such as a ROM, a RAM, a hard disk, a CD-ROM, and a DVD, or a combination of the storage media.

The processor 630 may control a series of processes for the network entity to operate according to an embodiment of the disclosure described above. Also, the processor 630 may include at least one processor. The methods according to the embodiments of the disclosure described in the claims or the detailed description of the disclosure may be implemented in hardware, software, or a combination of hardware and software.

When implemented in software, a computer-readable storage medium storing one or more programs (e.g., software modules) may be provided. The one or more programs stored in the computer-readable storage medium are configured for execution by one or more processors in an electronic device. The one or more programs include instructions directing the electronic device to execute the methods according to the embodiments of the disclosure as described in the claims and the specification.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in memory including a combination of some or all of the above-mentioned storage media. A plurality of such memories may be included.

The programs may also be stored in an attachable storage device which is accessible through a communication network such as the Internet, an intranet, a local area network (LAN), a wide area network (WAN), or a storage area network (SAN), or a combination thereof. Such a storage device may access the electronic device via an external port. Furthermore, an additional storage device on the communication network may access an apparatus that performs embodiments of the disclosure.

In the embodiments of the disclosure described above, elements included in the disclosure are expressed in a singular or plural form according to the embodiments of the disclosure. However, the singular or plural form is appropriately selected for convenience of explanation and the disclosure is not limited thereto. As such, an element expressed in a plural form may also be configured as a single element, and an element expressed in a singular form may also be configured as plural elements.

Meanwhile, specific embodiments of the disclosure have been described in the detailed description of the disclosure, but various modifications may be possible without departing from the scope of the disclosure. Therefore, the scope of the disclosure should not be limited to the embodiments of the disclosure described above, but should be determined not only by the scope of the following claims, but also by the equivalents of the claims.

A method performed by a UE, according to an embodiment of the disclosure, may include transmitting a registration request message to an AMF.

The method performed by the UE, according to an embodiment of the disclosure, may include receiving a registration accept message from the AMF.

The method performed by the UE, according to an embodiment of the disclosure, may include transmitting a PDU session establishment request message to an SMF.

The method performed by the UE, according to an embodiment of the disclosure, may include receiving a PDU session establishment accept message from the SMF.

The method performed by the UE, according to an embodiment of the disclosure, may include receiving a configuration update message from the AMF.

The configuration update message according to an embodiment of the disclosure may be configured based on update information related to a satellite RAN of the UE, received by the AMF from UDM.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment in a wireless communication system, the method comprising:
transmitting a registration request message to an access and mobility management function (AMF);
receiving a registration accept message from the AMF;
transmitting a protocol data unit (PDU) session establishment request message to a session management function (SMF);
receiving a PDU session establishment accept message from the SMF; and
receiving a configuration update message from the AMF,
wherein the configuration update message is configured based on update information related to a satellite radio access network (RAN) of the user equipment, received by the AMF from unified data management (UDM).
